(19) United States
(12) Patent Application Publication
(10) Pub. No.: US 2017/0248034 A1
(43) Pub. Date: Aug. 31, 2017

(54) POSITIONING SYSTEM FOR INDUSTRIAL MACHINE COUPLING ELEMENTS

(71) Applicant: General Electric Company, Schenectady, NY (US)

(72) Inventors: Piotr Krzysztof Dzieciol, Warsaw (PL); Sean Cornelius O'Meara, Schenectady, NY (US); Szymon Perkowski, Warsaw (PL); Wiktor Jan Wojciechowski, Pruszkow (PL)

(21) Appl. No.: 15/140,663

(22) Filed: Apr. 28, 2016

(30) Foreign Application Priority Data
Feb. 29, 2016 (PL) 416302

(51) Int. Cl. F01D 25/28; F04D 29/52; F04D 29/054; F01D 25/24

(52) U.S. Cl. CPC F01D 25/285; F01D 25/243; F04D 29/522; F04D 29/054; F05D 2220/32; F05D 2240/60

(57) ABSTRACT

A positioning system for aligning first and second coupling elements of adjacent sections of an industrial machine such as a shaft of a turbomachine or generator is provided. The system may include a base, and a pair of lifting jacks supported by the base for adjusting a vertical position of the first coupling element relative to the second coupling element. A coupling element support supports the first coupling element and is supported by the pair of lifting jacks on the base. An adjusting element positioned between each lifting jack and the coupling element support allows adjusting a position of the first coupling element relative to the second coupling element in the axial direction and a lateral direction substantially perpendicular to the axial direction.

### BACKGROUND OF THE INVENTION

The disclosure relates generally to industrial machines, and more particularly, to a positioning system for shaft alignment industrial machines such as a turbomachine and a generator.

Large industrial machines oftentimes include a number of sections that must be positioned and coupled together in a precise, aligned fashion to ensure proper operation. The extreme weight, size and varied mating shapes of the sections oftentimes makes alignment a very difficult task. One illustrative class of industrial machines in which sections must be aligned includes turbomachines such as gas turbines, steam turbines, compressors, etc. In one example of the sections requiring alignment for a compressor, an inlet casing must be precisely aligned with the turbine casing of the compressor. In another example of the sections requiring alignment for a turbomachine, a rotating shaft of a gas turbine must be precisely aligned with the shaft of a generator.

Conventionally, large turbomachine sections are positioned in a precise, aligned fashion during manufacture and held in position by structural beams. The coupled sections of the turbomachine are then installed in their work environment and any necessary fluid piping connections made thereafter. Currently, however, in certain situations, the fluid piping connections and other surroundings of the work environment are being installed prior to installation of the coupled turbomachine sections to, for example, shorten the installation cycle time. In this case, the turbomachine sections are installed separately in the work environment and then need to be precisely positioned and aligned in-place. Current techniques to position and align the sections rely on cranes, lifts and/or manual manipulation, all of which are imprecise and cumbersome. The need to precisely align sections in the field occurs relative to other industrial machines beyond just turbomachines.

### BRIEF DESCRIPTION OF THE INVENTION

A first aspect of the disclosure provides a positioning system for aligning first and second coupling elements of adjacent sections of an gas turbine, the gas turbine having an axial direction, the system comprising: a base; a pair of lifting jacks supported by the base for adjusting a vertical position of the first coupling element relative to the second coupling element; a coupling element support for supporting the first coupling element and supported by the pair of lifting jacks on the base; and an adjusting element positioned between each lifting jack and the coupling element support to adjust a position of the first coupling element relative to the second coupling element in the axial direction and a lateral direction substantially perpendicular to the axial direction.

A second aspect of the disclosure provides a positioning system for aligning first and second coupling elements of adjacent sections of a turbomachine, the turbomachine having an axial direction, the system comprising: a base; a pair of lifting jacks supported by the base for adjusting a vertical position of the first coupling element relative to the second coupling element; a coupling element support for supporting the first coupling element and supported by the pair of lifting jacks on the base, wherein the coupling element support includes a pair of opposing saddle members coupled by a beam; a stabilizer coupling the coupling element support to a portion of the turbomachine; and an adjusting element positioned between each lifting jack and the support member to adjust a position of the first coupling element relative to the second coupling element in the axial direction and a lateral direction substantially perpendicular to the axial direction.

A third aspect of the disclosure provides a positioning system for aligning first and second coupling elements of adjacent sections of an industrial machine, the industrial machine having an axial direction, the system comprising: a base; a pair of lifting jacks supported by the base for adjusting a vertical position of the first coupling element relative to the second coupling element; a coupling element support for supporting the first coupling element and supported by the pair of lifting jacks on the base; and an adjusting element positioned between each lifting jack and the coupling element support to adjust a position of the first coupling element relative to the second coupling element in the axial direction and a lateral direction substantially perpendicular to the axial direction.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a perspective view of an illustrative industrial machine with a positioning system according to embodiments of the disclosure.

FIG. 2 shows a perspective front view of a positioning system according to embodiments of the disclosure.

FIG. 3 shows another perspective front view of a positioning system according to embodiments of the disclosure.

FIG. 4 shows a side view of a positioning system according to embodiments of the disclosure.

FIG. 5 shows an enlarged perspective side view of a positioning system according to embodiments of the disclosure.

FIG. 6 shows a perspective side view of a positioning system according to embodiments of the disclosure.

FIG. 7 shows an enlarged perspective lower view of an adjusting element of a positioning system according to embodiments of the disclosure.

FIG. 8 shows a partial cross-sectional view of one embodiment of the adjusting element of FIG. 7.

FIG. 9 shows a partial cross-sectional view of another embodiment of the adjusting element of FIG. 7.

FIG. 10 shows a partial cross-sectional, plan view from below of an adjusting element of a positioning system according to embodiments of the disclosure.

FIG. 11 shows a partial cross-sectional, plan view from below of an adjusting element of a positioning system according to another embodiment of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As indicated above, the disclosure provides a positioning system for precisely positioning and/or aligning first and second coupling elements of adjacent sections of an industrial machine. Embodiments of the disclosure will be described relative to an industrial machine in the form of a gas turbine power generating system that requires alignment of a rotating shaft of a gas turbine section thereof with the rotating shaft of an adjacent generator section thereof. In particular, the disclosure illustratively describes aligning a gas turbine inlet casing, and hence rotating shaft coupling element therein, with a compressor casing and hence the rotating shaft coupling element that extends therein which is coupled to, or part of, the rotating shaft of an adjacent generator section (not shown). In another setting, the teachings of the disclosure may be applied to aligning and coupling casing sections of a compressor. It is emphasized that embodiments of the disclosure can be applied to a wide variety of different turbomachines, e.g., steam turbines, etc., and a large variety of different industrial machines, with minor modifications. As such, the term “sections” can apply to any parts of any industrial machine, e.g., casings of a compressor, rotating shafts, etc., and also what may be considered whole industrial machines, e.g., gas turbines and generators. Embodiments of the disclosure will also be described relative to an in-the-field installation setting for the gas turbine turbomachine. The teachings of the disclosure, as will be apparent, can be applied in practically any setting, including a manufacturing setting.

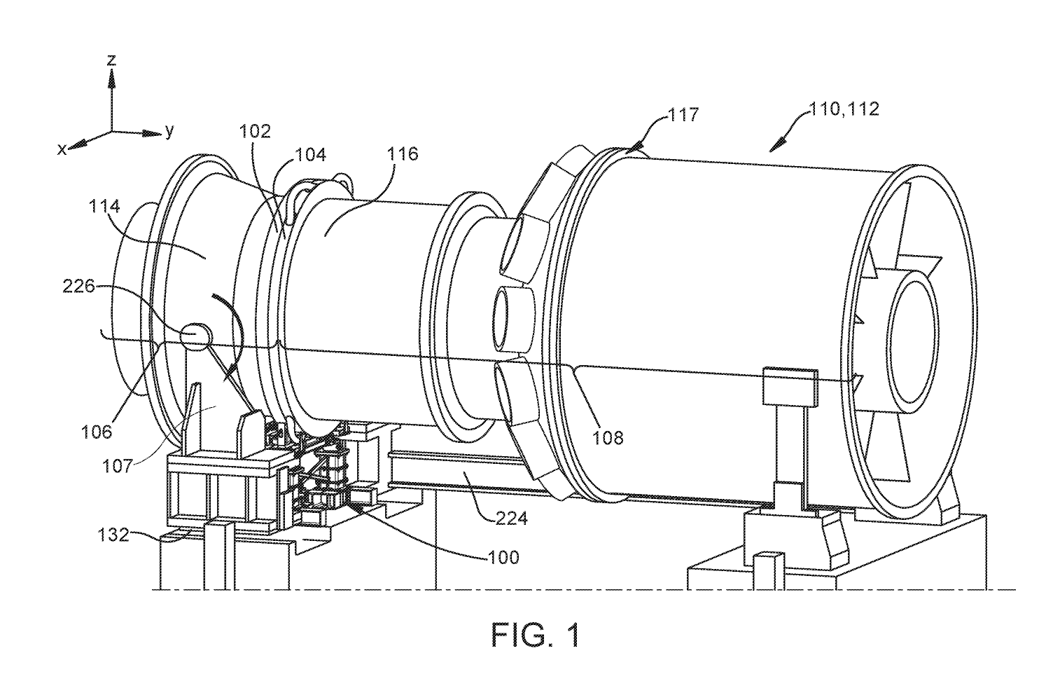

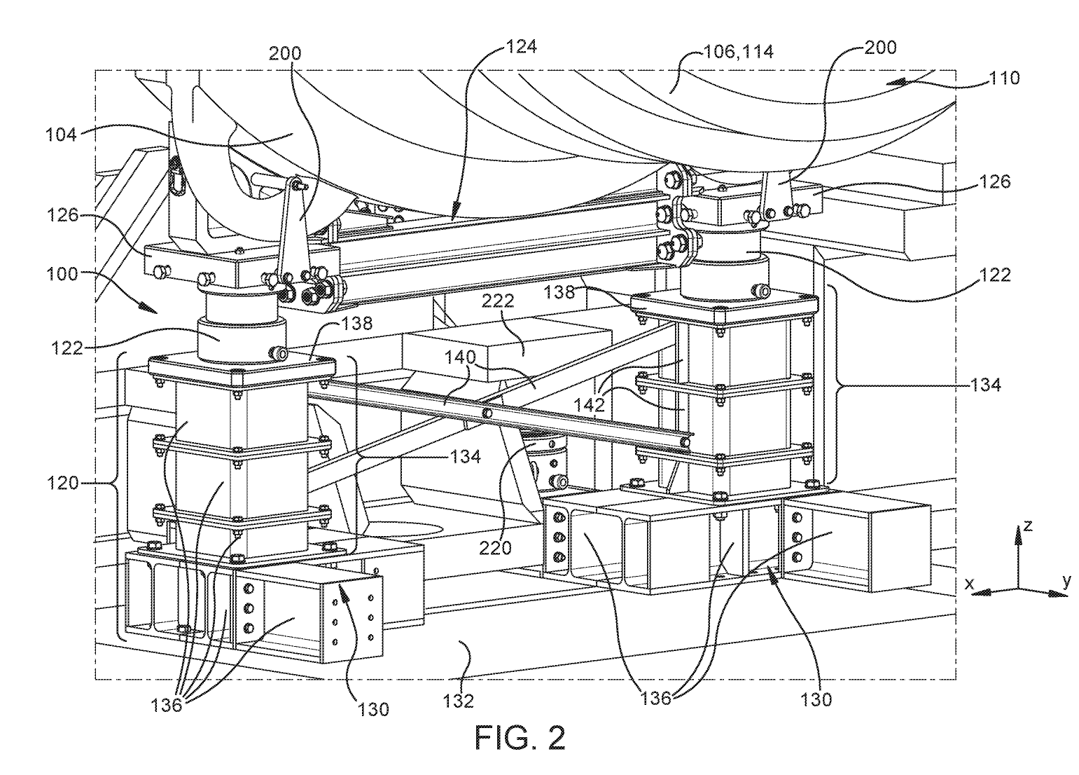

Referring to FIGS. 1 and 2, a positioning system 100 for positioning and/or aligning first and second coupling elements 102, 104 (FIG. 1) of adjacent sections 106, 108 (FIG. 1) of an industrial machine 110 is illustrated. FIG. 1 shows a perspective view showing positioning system 100 in position under an illustrative industrial machine 110 in the form of a gas turbine 112, and FIG. 2 shows a more detailed perspective view of positioning system 100 in position under industrial machine 110, i.e., gas turbine 112. In the position illustrated, section 106 includes an inlet casing 114 at a forward end of gas turbine 112 having first coupling element 102 and section 108 includes a compressor casing 116 having second coupling element 104. As understood, a rotating shaft extends within each coupling element such that alignment of the rotating shaft can be achieved by adjusting the position of the coupling elements. As such, “coupling elements” may refer to sections of machine casings or sections of rotating shafts within the casings. Section 110 also is shown including a combustor 117 of gas turbine turbomachine 112. First and second coupling elements 102, 104 must be aligned in an axial direction Y, a lateral direction X substantially perpendicular to axial direction Y, and in a vertical direction Z, also substantially perpendicular to axial direction Y. As understood, once aligned, first and second coupling elements 102, 104 are coupled together using any now known or later developed technique, e.g., bolts, welding, clamps, etc. Further, the rotating shafts therein can be coupled together in a conventional fashion. First and second coupling elements 102, 104 may include any now known or later developed structures for coupling sections 114, 116 of gas turbine 112, e.g., heavy duty flanges including mating connector openings.

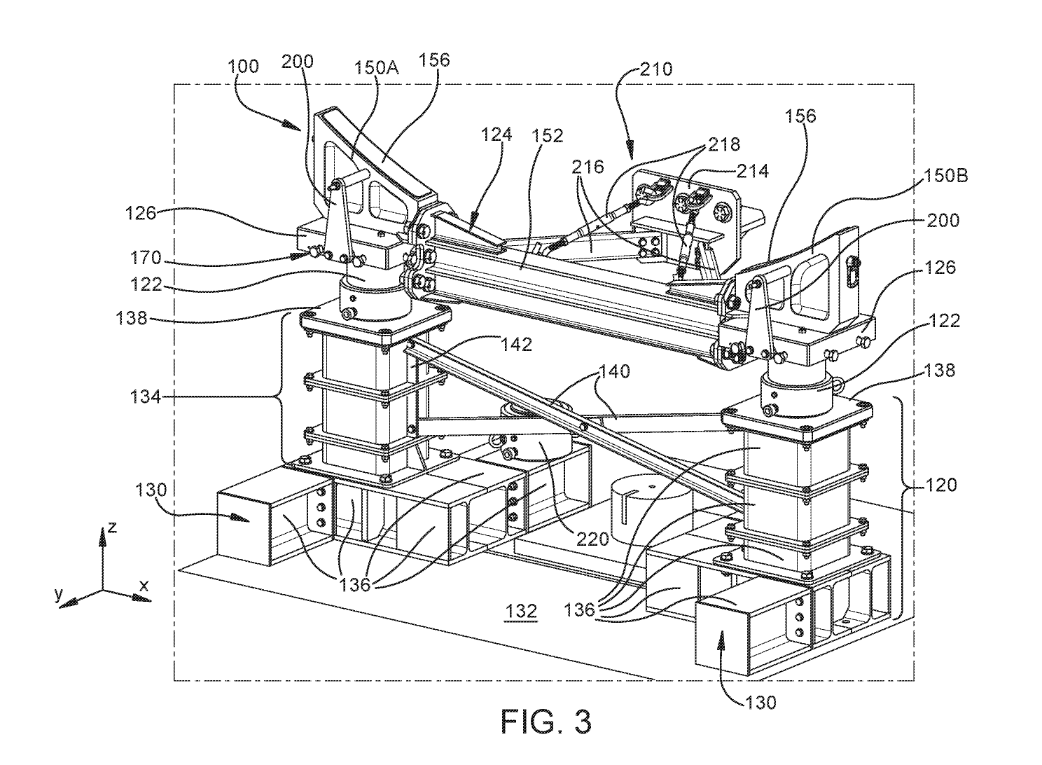

Referring to FIGS. 2 and 3, positioning system 100 generally includes four sections: a base 120, a pair of lifting jacks 122, a coupling element support 124 and an adjusting element 126 positioned between each lifting jack 122 and coupling element support 124.

Base 120 may take the form of any structure capable of stably positioning lifting jacks 122 and coupling element support 124 in position to support first coupling element 102. In the illustrative embodiment shown in FIGS. 2-4, base 120 may include a pair of base supports 130 configured to engage a foundation 132 of industrial machine 110. Foundation 132 may include any fixed surface upon which, or adjacent to which, industrial machine 110 is positioned. A stand 134 may extend upwardly from each base support 130 to support a respective lifting jack 122.

In accordance with embodiments of the disclosure, positioning system 100 may be portable such that it may be readily moved and assembled in various locations where it is needed. To this end, base supports 130 and stands 134 may each include a plurality of sections 136. Sections 136 may take a variety of shapes and sizes depending on the application of positioning system 100. Each section 136 can be selectively fastened to other sections using any now known or later developed fasteners, e.g., male-female connectors, bolts/nuts, bolts with threaded openings, cotter pins, etc. Each section 136 may include any form of structural support, e.g., I-beam, box beam, etc., and may provide for a variety of alternative connection locations to adjacent sections 136. Each base support 130 and stand 134 may have any shape and area coverage to stably position stands 134, jacks 122 and coupling element support 124. In the example shown, base supports 130 have a section 136 under each stand 134 extending in a lateral direction X and a pair of sections 136 extending in axial direction Y. Similarly, in the example shown, each stand 134 includes three (3) sections 136 of identical cross-section, each section having a different height. The different heights, however, is not necessary in all instances. Each stand 134 may have a section 136 having an upper end 138, e.g., a platform or surface, upon which jacks 122 are positioned. As understood, base supports 130 and stands 134, and accordingly sections 136 thereof, can have a large variety of alternative shapes and sizes to accommodate different situations.

As shown in FIGS. 2 and 3, base 120 may also optionally include at least one cross-beam 140 coupling stands 134 to one another. In the example shown, two cross-beams 140 are coupled together in a scissor or pivotable arrangement. However, cross-beam(s) 140 can be provided in any fashion to stabilize stands 134, e.g., parallel. Cross-beam(s) 140 may be coupled to stands 134 (or base supports 130) using any now known or later developed fasteners, e.g., male-female connectors, bolts/nuts, bolts with threaded openings, cotter pins, etc. Preset locations for cross-beam(s) 140 may be provided, or they can be selectively affixed based on the situation, e.g., via various openings in a flange(s) or rib(s) 142 in one or more sections 136 of stands 134 or base supports 130. Cross-beam(s) 140 may not be necessary in all instances.

Pair of lifting jacks 122 are supported by base 120, e.g., on platforms 138 of stands 134, for adjusting a vertical position of first coupling element 102 relative to second coupling element 104. More particularly, lifting jacks 122 vertically adjust a position of coupling element support 124, which supports first coupling element 102. Each lifting jack 122 may include any now known or later developed powered lifting jack capable of moving its respective portion of the load of first coupling element 102 and the structure to which element 102 is attached. Lifting jacks 122 may be pneumatically, hydraulically and/or electrically powered, and may include any conventional electronic controls (not shown) necessary to ensure proper operation. Lifting jacks 122 may operate in a synchronous or asynchronous manner, depending on the application. Lifting jacks 122 may be positioned on platforms 138 and against adjusting element 126, or they may be fixedly coupled to platforms 138 and/or adjusting element 126. In the latter case, any now known or later developed manner of coupling lifting jacks 122 in position may be employed, e.g., welds, positioning ribs, bolts or other fasteners, etc.

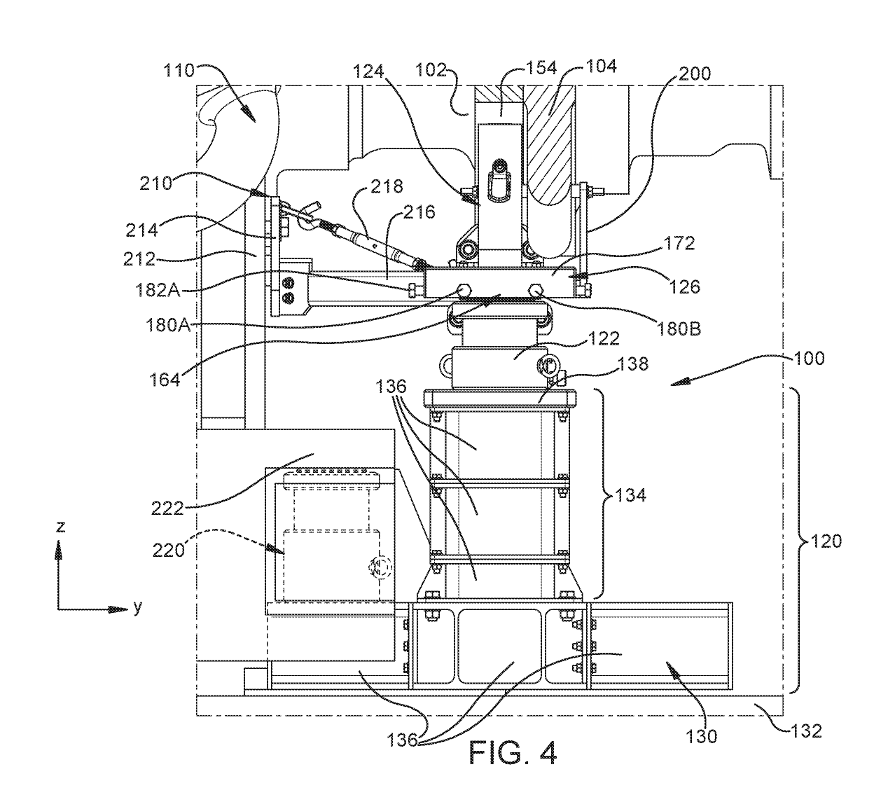

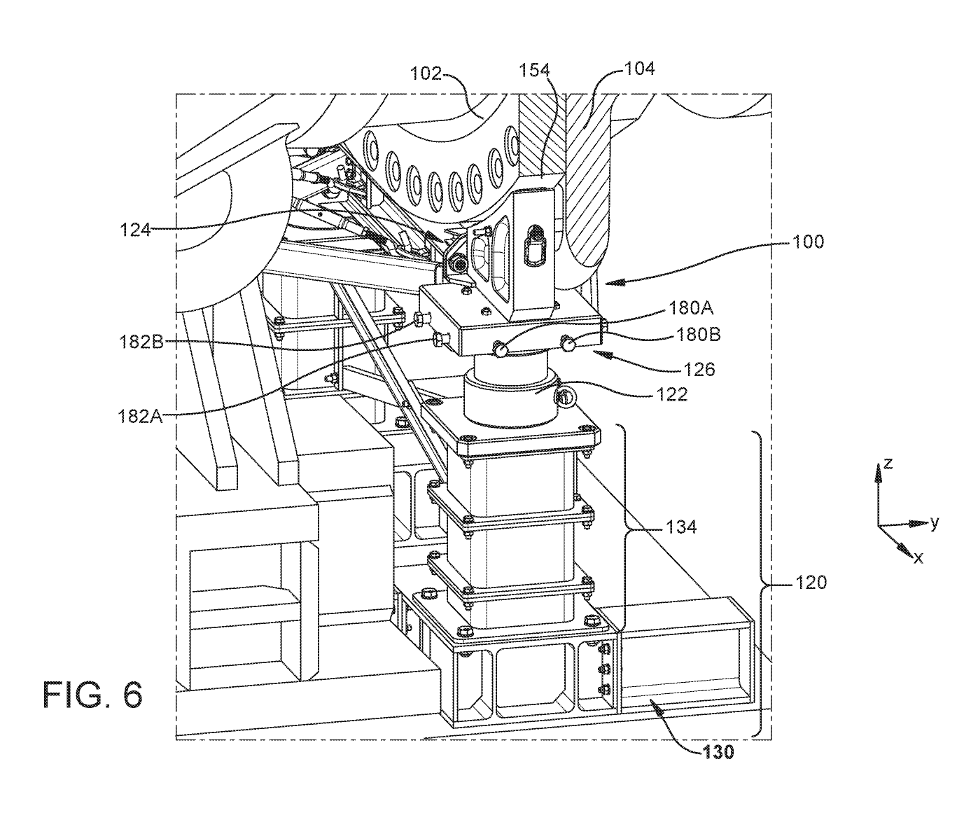

Coupling element support 124 supports first coupling element 102, either directly or indirectly, and is supported by pair of lifting jacks 122 on base 120, with adjusting elements 126 therebetween. Coupling element support 124 may take any form capable of supporting first coupling element 102 (regardless of coupling element structure) and being supported by jacks 122. In one embodiment, shown best in FIG. 3, coupling element support 124 may include a pair of opposing saddle members 150A, 150B coupled by a beam 152. Saddle members 150A, 150B may be coupled to beam 152 in any fashion. In keeping with positioning system 100 portability, members 150A, 150B may be coupled to beam 152 with releasable fasteners, e.g., bolts, nuts, cotter pins, etc., so coupling element support 124 can be readily assembled, disassembled and/or moved. In any event, each saddle member 150A, 150B is supported by a respective adjustment element 126, described herein, and engages with a portion 154 (FIGS. 4-6 and 8) of first coupling element 102. In order to better engage and support portions 154 of first coupling element 102, as shown in FIG. 3, each saddle member 150A, 150B may include a conforming surface 156 configured to conform to an outer surface of first coupling element 102. Conforming surface 156 may include a layer of, for example, a soft metal such as copper, a polymer, a rubber, etc. It is emphasized that coupling element support 124 and/or saddle members 150A, 150B can take any form capable of supporting the requisite section of gas turbine 112, and can therefore have a wide variety of shapes other than that shown.

Referring to FIGS. 3 and 6-11, adjusting elements 126 are provided to adjust a position of first coupling element 102 relative to second coupling element 104 in axial direction Y and a lateral direction X substantially perpendicular to axial direction Y. That is, adjusting elements 126 are provided to allow for fine tuning of the horizontal planar position of first coupling element 102 such that first coupling element 102 can be precisely positioned horizontally relative to second coupling element 104. As will be described, the level of “fine tuning” provided can be user selected, but may range, for example, from approximately 0.01-5.00 centimeters. As used herein, “approximately” indicates+/−10% of the value stated, or values, if a range.

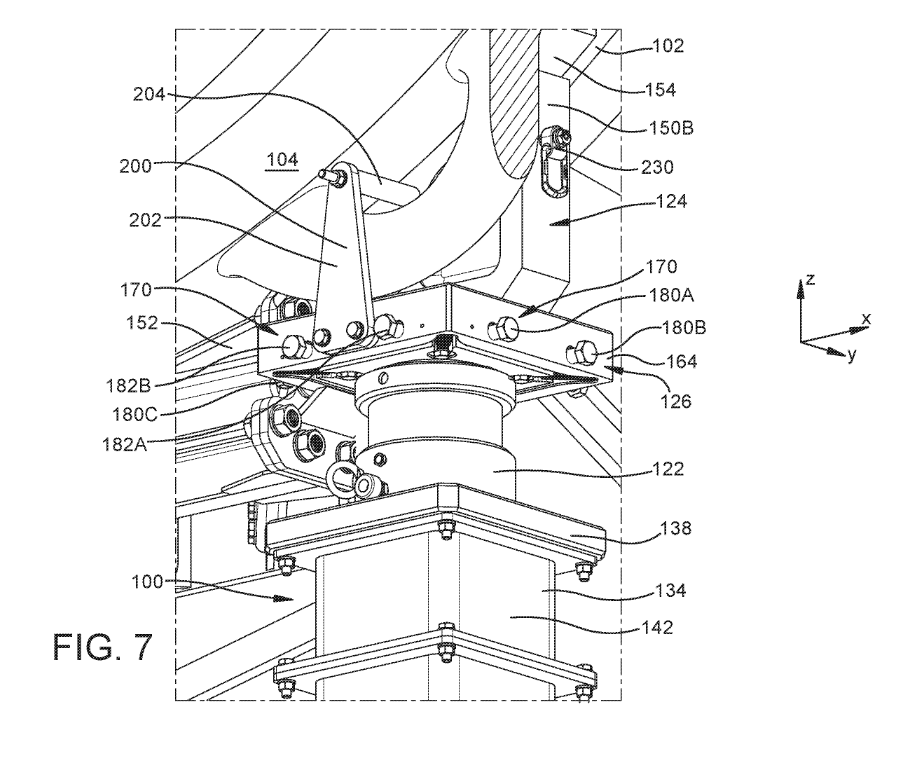

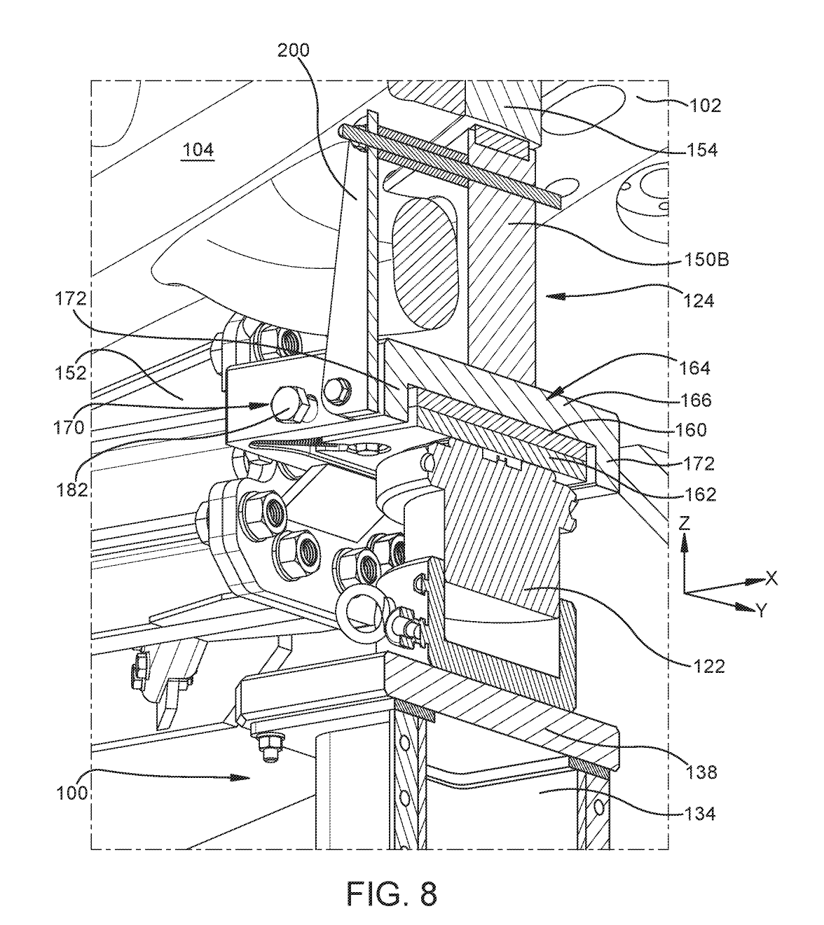

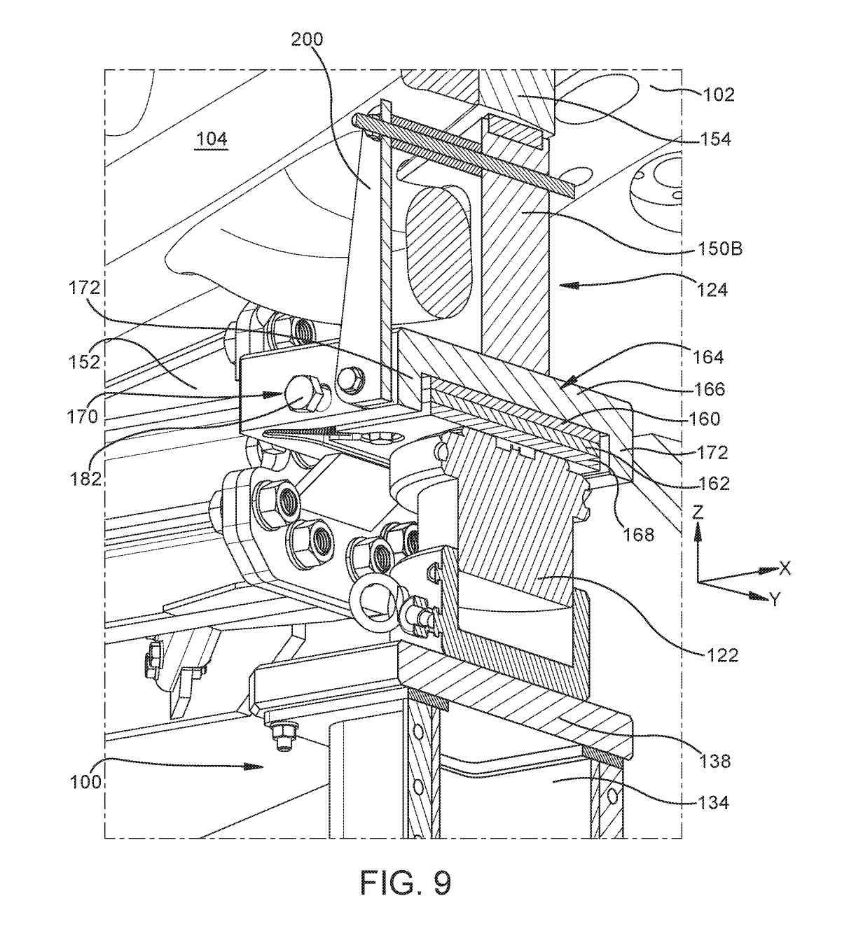

FIG. 7 shows a perspective view of an adjusting element 126, and FIGS. 8 and 9 show partial cross-sectional views of adjusting element 126 from the perspective of FIG. 7. Each adjusting element 126 may take a variety of forms that allow for fine-tuned, horizontal position adjustment of first coupling member 102. In one embodiment, as shown best in FIGS. 8 and 9, each adjusting element 126 may include a first slide member 160 coupled to coupling element support 124, and a second slide member 162 coupled to a respective lifting jack 122 and in sliding engagement with first slide member 160. Each slide member 160, 162 may include any material allowing relatively smooth movement of each member 160, 162 relative to one another. In one embodiment, shown in FIG. 8, one or both members 160, 162 may entirely include a low friction polymer. In this case, first slide member 160 is affixed to a movement restricting member 164, described further herein, and second slide member 162 is coupled to lift jack 122, either directly or indirectly. In another embodiment, shown in FIG. 9, each sliding member 160, 162 may include a low friction (polymer) plate (shown as 160, 162 for clarity) and a backing plate 166, 168, e.g., of another stronger material such as metal. In this case, a backing plate 166 of first slide member 160 may be part of movement restricting member 164, and a backing plate 168 of second slide member 162 may be coupled to lifting jack 122, either directly or indirectly. In the embodiments described herein, the low friction polymer may include but is not limited to: a phenolic, nylon, acetal (Delrin), polytetrafluoroethylene (PTFE)(Teflon®), and/or ultra-high-molecular weight polyethylene.

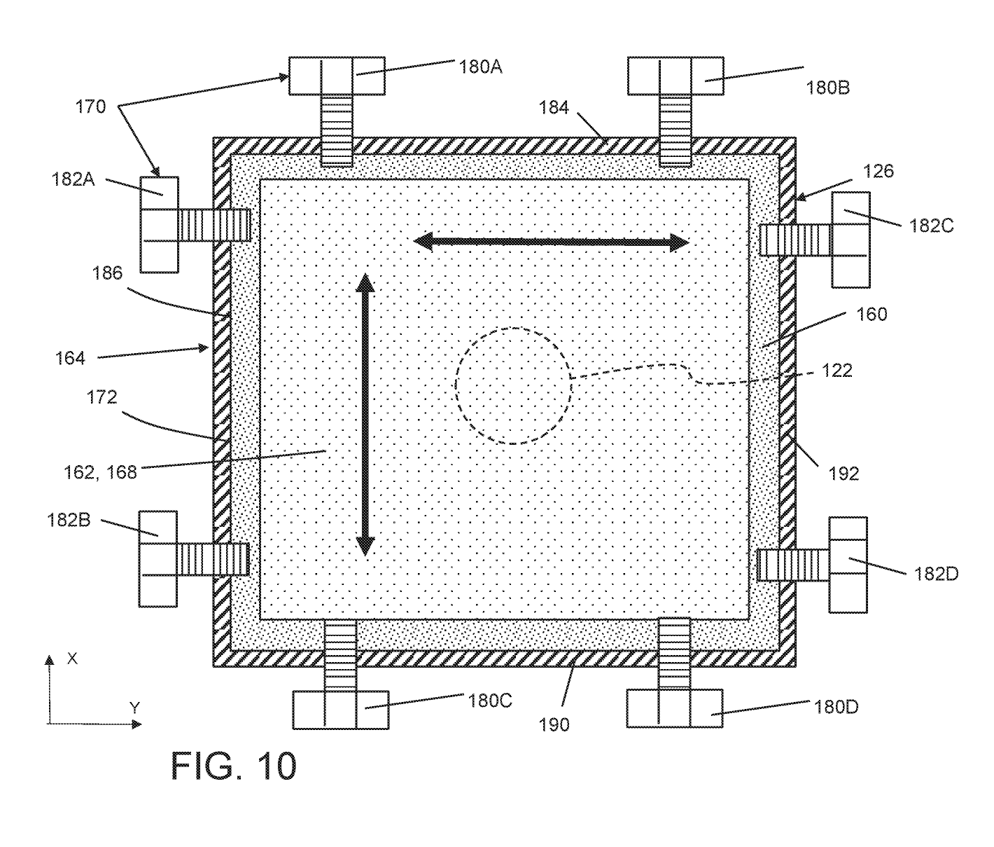

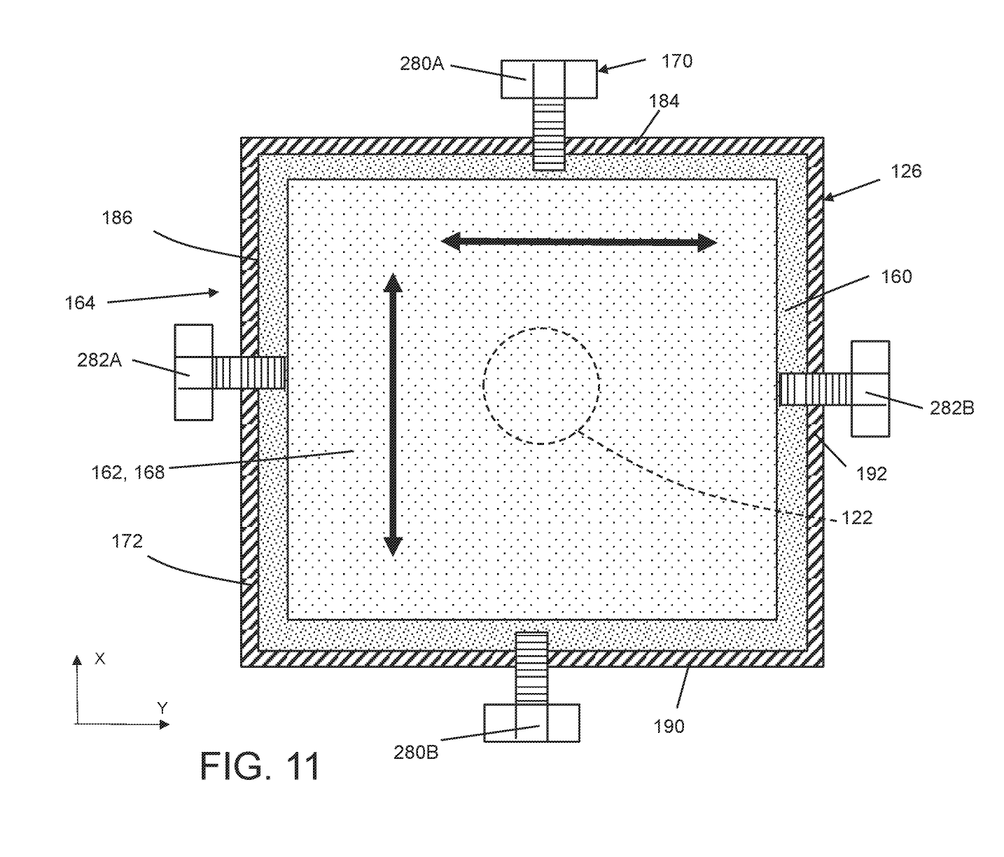

Referring to FIGS. 7-9, each adjusting element 126 may also include movement restricting member 164 coupled to first sliding member 160 and limiting movement of first and second sliding members 160, 162 relative to one another in axial direction Y and lateral direction X. Further, each adjusting element 126 may include an adjustable positioning member, generally noted 170, interacting with movement restricting member 164 to position first sliding member 160 relative to second sliding member 162 to adjust a position of first coupling element 102 relative to second coupling element 104 in at least one of axial direction Y and lateral direction X. As observed best in FIGS. 10 and 11, which show partial cross-sectional plan views of embodiments of adjusting element 126, movement restricting member 164 includes an outer wall 172 configured to surround second sliding member 162 in a spaced manner. That is, outer wall 172 extends about second sliding member 162 and provides a limited amount of movement to second sliding member 162 in a horizontal plane. The amount of movement allowed can be selected according to any number of factors such as but not limited to: the tolerances required to align coupling elements 102, 104, the size of coupling elements 102, 104, the amount of available space around gas turbine 112, etc. In any event, the amount of movement allowed should be, when positioning system 100 is properly positioned, sufficient to provide accurate alignment of coupling elements 102, 104. In one example, the amount of movement may be twice that stated for the fine-tuning, e.g., approximately 0.02-10.00 centimeters. If more movement is desired than initially provided by adjusting member 126, adjusting element 126 position relative to coupling element support 124 can be reset, e.g., by providing some alternative support to first coupling member 102 (cribbing, etc.), backing coupling element support 124 away from alternatively supported first coupling member 102, adjusting the horizontal position of adjusting element 126 relative to coupling member 102 and re-engaging coupling element support 124 with the coupling member.

Adjustable positioning member 170 may take any variety of forms that provide precise positioning of first and second slide members 160, 162 with regard to one another as limited by movement restriction member 164, resulting in precise horizontal positioning of coupling elements 102, 104 relative to one another. FIGS. 10 and 11 show upwardly viewing, partial cross-sectional views from lifting jack 122 of adjusting element 126, and in particular, movement restricting member 164. In embodiments of the disclosure, as shown in FIGS. 10 and 11, adjustable positioning member 170 may include a first set of threadably adjustable elements 180 (A-D or A-B) extending through outer wall 172 of movement restricting member 164 to position second sliding member 162 relative to first sliding member 160 in lateral direction X, and a second set of threadably adjustable elements 182 (A-D or A-B) extending through outer wall 172 to position second sliding member 162 relative to first sliding member 160 in axial direction Y. Adjustment of each set of elements 180, 182 acts to slidingly move second sliding member 162 (shown in FIGS. 10, 11 with identically shaped backing plate 168) relative to first sliding member 160 (within outer wall 172 of movement restricting member 164); allowing precise positioning and/or alignment of coupling elements 102, 104 relative to one another. Adjustment of set 180 adjusts the position of second sliding member 162 in a lateral direction X, and adjustment of set 182 adjusts the position of sliding member 162 in an axial direction Y, each limited by the amount of space allowed by outer wall 172 of movement restricting member 164.

Each threadably adjustable element 180, 182 may include a stem (unnumbered) threadably seated in outer wall 172 and having any desired thread count desired to provide precise adjustment. For example, thread count of each element 180, 182 may be set to provide a predetermined adjustment of sliding member 162 per predetermined turning amount of the respective element(s) 180, 182. As one example, a quarter turn of an element 180, 182 may result in 0.25 mm adjustment of sliding member 162. Each threadably adjustable element 180, 182 may also have any form of head adjustable by conventional tools/technique, e.g., bolt (shown), screwdriver, torx, hand gripping threads, etc. Each set of threadably adjustable elements 180, 182 may include any number of adjustable elements capable of providing the desired precision and position of second sliding member 162 relative to first sliding member 160. In one embodiment, shown in FIG. 10, each set of threadably adjustable elements 180, 182 may include a first pair of threadably adjustable elements 180A-B and 182A-B in a first face 184, 186, respectively, of outer wall 172, and a second pair of threadably adjustable elements 180C-D and 182C-D in an opposing second face 190, 192, respectively, of outer wall 172. That is, set 180 includes four (4) threadably adjustable threaded elements 180A-D, two (2) on each opposing face of outer wall 172-180A-B on face 184, and 180C-D on face 190. And, set 182 includes four (4) threadably adjustable threaded elements 182A-D, two (2) on each opposing face of outer wall 172-182A-B on face 186, and 180C-D on face 192. With pairs of opposing threadably adjustable elements, second sliding member 162 can be very precisely horizontally positioned with some minor amount of angular shift relative to the respective lateral or axial direction.

In operation, all but a selected pair of elements on one face 184, 186, 190, 192 are backed off of contact with sliding member 162 on at least one, but typically both, adjusting elements 126. The selected pair of elements are then turned to advance their respective stems against sliding member 162 to move the member in the desired direction and by the desired amount. In FIG. 10, for example, elements 180A,B, 182A-D are backed off sliding member 162, but elements 180C, 180D remain in contact with sliding member 162 such that advancement thereof will move the member along lateral direction X (upward as shown). The process can be repeated using another selected pair of elements to move sliding member 162 in the other direction. For example, elements 180C, 180D may be backed off and pair of elements 182A, 182B or elements 182C, 182D may be moved into engagement with sliding member 162 to move sliding member 162 along the axial direction Y. In another example, elements 180C, 180D may be backed off and pair of elements 180A, 180B may be moved into engagement with sliding member 162 to move sliding member 162 in the opposite, lateral direction X (downward as shown). As is apparent, the process can be repeated using each pair of elements 180, 182 on one or both adjusting elements 126 until first and second coupling elements 102, 104 are in the desired position.

Referring to FIG. 11, while opposing pairs of threadably adjustable elements 180, 182 have been illustrated in most of the drawings, alternative embodiments may not require as many threadably adjustable elements. In FIG. 11, for example, only opposing single threadably adjustable elements 280A-B on faces 184, 190, respectively, and elements 282A-B on faces 186, 192 are employed. Operation would be as explained above, except only individual elements 280, 282 would need adjusting on one or both adjusting elements 126.

Positioning system 100 may also include a number of optional structures that provide additional stability and/or safety.

In one embodiment, shown in FIGS. 2-5 and 7-9, positioning system 100 may include a safety collar 200 extending from at least one adjustment element 126 (both shown) to limit movement of second coupling element 104 in at least one of axial direction Y and a vertical direction Z. Safety collar 200 can take a variety of forms. In one embodiment, as shown in FIG. 7, each safety collar 200 may include a plate member 202 bolted to outer wall 172 of movement restricting member 164, and a pin connector 204 that extends through a part of second coupling element 104 and is coupled to coupling element support 124, e.g., saddle member 150A, 150B.

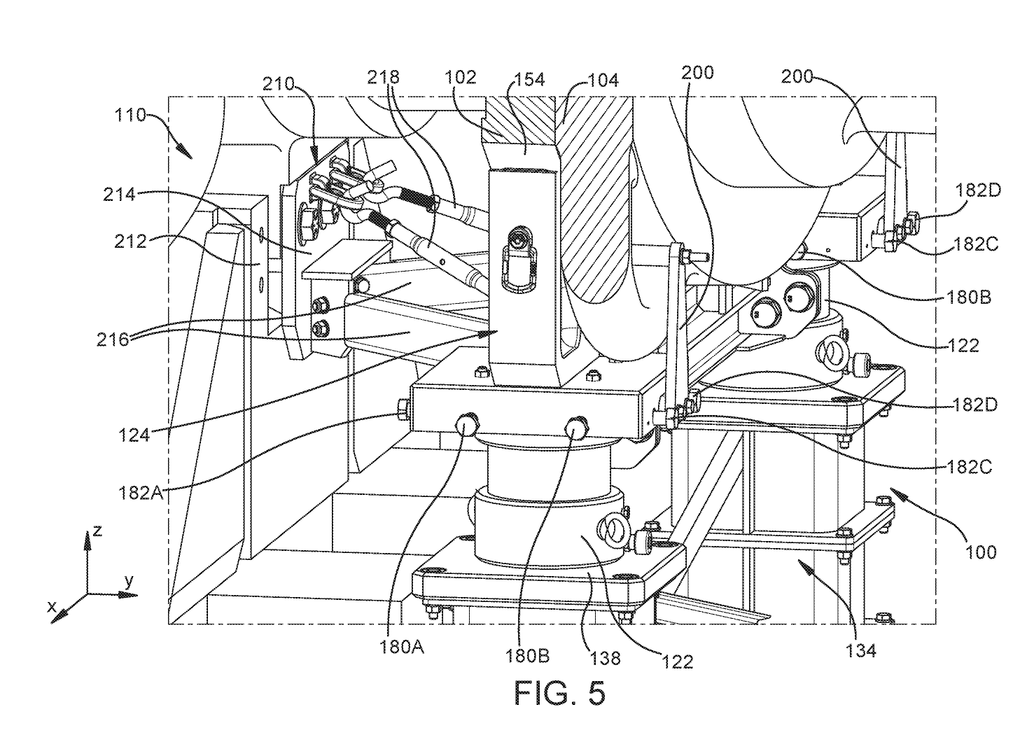

Positioning system 100 may also include, as shown best in FIGS. 3-5, a stabilizer 210 coupling the coupling element support 124 to a portion 212 (FIGS. 4 and 5) of industrial machine 110. Portion 212 may include any stable part of industrial machine 110 (FIGS. 4-5), e.g., a pier extending from foundation 132. Stabilizer 210 can take any form of structure capable of adding stability and fixed positioning of coupling element support 124, and consequently, all of positioning system 100. In one embodiment, stabilizer 210 may include a mount 214 for coupling to portion 212 of industrial machine 110. Mount 214 may include, for example, any number of metal plates configured to be coupled to portion 212, e.g., using bolts, clamps or other fasteners. Stabilizer 210 may also include at least one fixed length member 216 for fixedly coupling the coupling element support 124 to mount 214. In the example shown, two fixed length members 216 in a V-shape couple mount 214 to coupling element support 124, and in particular, to beam 152 of coupling element support 124, e.g., using bolts or other removable fasteners. Each fixed length member 216 may include any structural member capable of holding positioning system 100 in position, e.g., I-beams, box beams, etc. As an option, stabilizer 210 may also include at least one length adjustable member 218 for adjustably coupling the coupling element support 124 to mount 214. More particularly, length adjustable member 218 may be provided to assist in properly positioning the positioning system 100 relative to portion 212, e.g., by gradually maneuvering coupling element support 124 into position. Each length adjustable member 218 may include any structure capable of adjustably changing length and withstanding the load applied such as but not limited to industrial turnbuckles or come-alongs. Member(s) 218 may be coupled to mount 214 and coupling element support 124, e.g., beam 152, by any means such as eyelets. While two length adjustable members 218 are illustrated, any number may be employed. Stabilizer 210 may be sectioned like the rest of positioning system 100 for easy assembly, disassembly and/or movement.

In another embodiment, shown in FIGS. 2-4, positioning system 100 may also further include a machine stabilizing jack 220 configured to engage a portion 222 of industrial machine 210 to stabilize a section, e.g., section 106 (FIG. 1), of industrial machine 110 during aligning of first coupling element 102 and second coupling element 104. Portion 222 is shown as a ‘pocket’ on industrial machine 210, but may include any element upon which stabilizing jack 220 may act. Referring to FIG. 1, during coupling of the first and second coupling elements 102, 104, where no support beams 224 (one shown in back, but front counterpart removed) are provided on industrial machine 110, sections 106, 108 are able to move relative to another. For example, when support beams 224 are not present, supports 107 for section 106 of industrial machine 110 may have a tendency to rotate clockwise (as shown by arrow in FIG. 1) or sway about a pivot mount 226 thereof on foundation 132. Machine stabilizing jack 220 may be provided to support portion 222 to prevent the rotation, i.e., provide a counterclockwise (as shown) force on section 107. Machine stabilizing jack 220 may be provided in any location in which it can safely act on portion 222, e.g., on foundation 132 or, as shown, supported by a section 136 of base 120. Machine stabilizing jack 222 may include any of the afore-mentioned jacks 122, and be controlled in a similar fashion. One or two machine stabilizing jacks 220 may be employed. If two are employed, one each can be placed relative to base supports 130.

Each part of positioning system 100, excepting sliding members 160, 162, is made of any structural metal, such as steel, capable of withstanding the loads placed thereon. As noted, positioning system 100 is ideally sectioned so as to be portable. It is understood, however, that certain parts of positioning system 100 may be permanently affixed together if they do not present too much burden to assemble collectively to adjoining structure. For example, fixed length members 216 of stabilizer 210 may be permanently affixed to mount 214, e.g., by welding. Each section may also include a lift member 230 (e.g., a hole therein or eyelet), as shown for example on saddle member 150B in FIG. 7, for ease of carrying by a crane, lift truck, etc. In addition, while certain parts of positioning system 100 have been described herein and illustrated as being provided in pairs, it is understood that, where necessary, those parts may be duplicated and provided in greater numbers than just pairs.

Positioning system 100 provides a mechanism to position and/or align coupling elements of different sections of an industrial machine in a safe, crane-free and precise manner. System 100 also allows alignment of industrial machine axis (e.g., of rotating shaft) to meet important tolerances. System 100, provided with machine stabilizing jack 220, also enables lifting of a section of the industrial machine, e.g., a gas turbine turbomachine 112, to remove or access mechanical actuators underneath, which saves a large amount of installing time in case of damage.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A positioning system for aligning first and second coupling elements of adjacent sections of a gas turbine, the gas turbine having an axial direction, the system comprising:
a base;
a pair of lifting jacks supported by the base for adjusting a vertical position of the first coupling element relative to the second coupling element;
a coupling element support for supporting the first coupling element and supported by the pair of lifting jacks on the base; and
an adjusting element positioned between each lifting jack and the coupling element support to adjust a position of the first coupling element relative to the second coupling element in the axial direction and a lateral direction substantially perpendicular to the axial direction.

2. The positioning system of claim 1, wherein each adjusting element includes:
a first slide member coupled to the coupling element support;
a second slide member coupled to a respective lifting jack and in sliding engagement with the first slide member;
a movement restricting member coupled to the first sliding member and limiting movement of the first and second sliding members relative to one another in the axial direction and the lateral direction; and
an adjustable positioning member interacting with the movement restricting member to position the first sliding member relative to the second sliding member to adjust a position of the first coupling element relative to the second coupling element in at least one of the axial direction and the lateral direction.

3. The positioning system of claim 2, wherein each sliding member includes a low friction plate and a metal backing plate.

4. The positioning system of claim 2, wherein the movement restricting member includes an outer wall configured to surround the second sliding member in a spaced manner, and
wherein the adjustable positioning member includes a first set of threadably adjustable elements extending through the outer wall to position the second sliding member relative to the first sliding member in the lateral direction, and a second set of threadably adjustable elements extending through the outer wall to position the second sliding member relative to the first sliding member in the axial direction.

5. The positioning system of claim 4, wherein each set of threadably adjustable elements includes a first pair of threadably adjustable elements in a first face of the outer wall, and a second pair of threadably adjustable elements in an opposing second face of the outer wall.

6. The positioning system of claim 1, wherein the coupling element support includes a pair of opposing saddle members coupled by a beam, and wherein each saddle member is supported by a respective adjustment element and engages with a portion of the first coupling element.

7. The positioning system of claim 6, further comprising a safety collar extending from at least one adjustment element to limit movement of the second coupling element in at least one of the axial direction and a vertical direction.

8. The positioning system of claim 6, wherein each saddle member includes a conforming surface configured to conform to an outer surface of the first coupling element.

9. The positioning system of claim 1, wherein the base includes:
a pair of base supports configured to engage a foundation of the gas turbine; and
a stand extending upwardly from each base support to support a respective lifting jack.

10. The positioning system of claim 9, wherein the base includes at least one cross-beam coupling the stands to one another.

11. The positioning system of claim 9, wherein the pair of base supports and the stands each include a plurality of sections.

12. The positioning system of claim 1, further comprising a stabilizer coupling the coupling element support to a portion of the gas turbine.

13. The positioning system of claim 12, wherein the stabilizer includes:
a mount for coupling to the portion of the gas turbine;
at least one length adjustable member for adjustably coupling the coupling element support to the mount; and
at least one fixed length member for fixedly coupling the coupling element support to the mount.

14. The positioning system of claim 1, further comprising a machine stabilizing jack configured to engage a section of the gas turbine to stabilize the gas turbine during aligning of the first coupling element and the second coupling element.

15. The positioning system of claim 14, wherein the machine stabilizing jack is supported by a portion of the base.

16. A positioning system for aligning first and second coupling elements of adjacent sections of a turbomachine, the turbomachine having an axial direction, the system comprising:
a base;
a pair of lifting jacks supported by the base for adjusting a vertical position of the first coupling element relative to the second coupling element;
a coupling element support for supporting the first coupling element and supported by the pair of lifting jacks on the base, wherein the coupling element support includes a pair of opposing saddle members coupled by a beam;
a stabilizer coupling the coupling element support to a portion of the turbomachine; and
an adjusting element positioned between each lifting jack and the support member to adjust a position of the first coupling element relative to the second coupling element in the axial direction and a lateral direction substantially perpendicular to the axial direction.

17. The positioning system of claim 16, wherein each adjusting element includes:
a first slide member coupled to the coupling element support;
a second slide member coupled to a respective lifting jack and in sliding engagement with the first slide member;
a movement restricting member coupled to the first sliding member and limiting movement of the first and second sliding members relative to one another in the axial direction and the lateral direction; and
an adjustable positioning member interacting with the movement restricting member to position the first sliding member relative to the second sliding member to adjust a position of the first coupling element relative to the second coupling element in at least one of the axial direction and the lateral direction.

18. The positioning system of claim 17, wherein the movement restricting member includes an outer wall configured to surround the second sliding member in a spaced manner, and
wherein the adjustable positioning member includes a first set of threadably adjustable elements extending through the outer wall to position the second sliding member relative to the first sliding member in the lateral direction, and a second set of threadably adjustable elements extending through the outer wall to position the second sliding member relative to the first sliding member in the axial direction.

19. The positioning system of claim 18, wherein each set of threadably adjustable elements includes a first pair of threadably adjustable elements in a first face of the outer wall, and a second pair of threadably adjustable elements in an opposing second face of the outer wall.

20. The positioning system of claim 16, further comprising a machine stabilizing jack configured to engage a portion of the turbomachine to stabilize the turbomachine during aligning of the first coupling element and the second coupling element.

21. A positioning system for aligning first and second coupling elements of adjacent sections of an industrial machine, the industrial machine having an axial direction, the system comprising:
a base;
a pair of lifting jacks supported by the base for adjusting a vertical position of the first coupling element relative to the second coupling element;
a coupling element support for supporting the first coupling element and supported by the pair of lifting jacks on the base; and
an adjusting element positioned between each lifting jack and the coupling element support to adjust a position of the first coupling element relative to the second coupling element in the axial direction and a lateral direction substantially perpendicular to the axial direction.

22. The positioning system of claim 21, wherein each adjusting element includes:
a first slide member coupled to the coupling element support;
a second slide member coupled to a respective lifting jack and in sliding engagement with the first slide member;
a movement restricting member coupled to the first sliding member and limiting movement of the first and second sliding members relative to one another in the axial direction and the lateral direction; and
an adjustable positioning member interacting with the movement restricting member to position the first sliding member relative to the second sliding member to adjust a position of the first coupling element relative to the second coupling element in at least one of the axial direction and the lateral direction.

23. The positioning system of claim 22, wherein the movement restricting member includes an outer wall configured to surround the second sliding member in a spaced manner, and
wherein the adjustable positioning member includes a first set of threadably adjustable elements extending through the outer wall to position the second sliding member relative to the first sliding member in the lateral direction, and a second set of threadably adjustable elements extending through the outer wall to position the second sliding member relative to the first sliding member in the axial direction.

24. The positioning system of claim 23, wherein each set of threadably adjustable elements includes a first pair of threadably adjustable elements in a first face of the outer wall, and a second pair of threadably adjustable elements in an opposing second face of the outer wall.

25. The positioning system of claim 21, wherein the coupling element support includes a pair of opposing saddle members coupled by a beam, and wherein each saddle member is supported by a respective adjustment element and engages with a portion of the first coupling element.
